(19) United States
(12) Patent Application Publication
(10) Pub. No.: US 2014/0324523 A1
(43) Pub. Date: Oct. 30, 2014

(54) Missing String Compensation In Capped Customer Linkage Model

(71) Applicant: WAL-MART STORES, INC., Bentonville, AR (US)

(72) Inventors: Andrew Benjamin Ray, Bentonville, AR (US); Nathaniel Philip Troutman, Seattle, WA (US)

(73) Assignee: Wal-Mart Stores, Inc., Bentonville, AR (US)

(21) Appl. No.: 13/874,365

(22) Filed: Apr. 30, 2013

(51) Int. Cl. G06Q 30/02

(52) U.S. Cl. CPC G06Q 30/0201
USPC 705/7.29

(57) ABSTRACT

The present disclosure extends to methods, systems, and computer program products for determining customer linkages between a plurality of customer profiles and providing missing cost values in the attribute fields.

### BACKGROUND

In the world of modern computer supported merchants, a large amount of data representing customer behavior can be compiled within a retail environment. Such data may have significant value for providing future services and goods to customers based on prior customer needs and desires. To provide even greater value the customer data should be processed and analyzed through various computation models in order to provide meaningful patterns from within the data. As a result, it is possible to be aware of customer behavior from a plurality of actions that may be attributable to a single customer that may then be indicative of future buying tendencies. Despite the advances in technology, records containing the customer data, such as customer profiles may be incomplete and have empty attribute fields. With current data comparing methods that are typically used for linearly comparing a plurality of records, missing attributes and empty attributes can return infinite and/or zero values during computer analysis. These infinite and zero values can overwhelm the comparison values generated by other corresponding attributes within the records being compared.

What is needed are methods and systems that are efficient at identifying missing or empty attribute fields and then generating substitute values that will be less impactful on the string comparison models. As will be seen, the disclosure provides such methods and systems that can compensate for missing attribute values in an effective and elegant manner.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example computer architecture that facilitates different implementations described herein;

FIG. 3 illustrates an example of customer profiles that may be linked in accordance with the teachings of the disclosure;

FIG. 4 illustrates an example method according to one implementation consistent with the principles of the disclosure; and

FIG. 5 illustrates a flow chart of an example method according to one implementation consistent with the teaching of the disclosure.

### DETAILED DESCRIPTION

The present disclosure extends to methods, systems, and computer program products for determining and building linkages between a plurality of records that represent or belong to the same customer. In the following description of the present disclosure, reference is made to the accompanying drawings, which form a part hereof, and in which is shown by way of illustration specific implementations in which the disclosure is may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

As used herein, the phrase “customer profile” is intended to denote a data set of customer information that may be used to identify a customer, and wherein customer information comprises attributes of the customer such as, for example: names, birthdate, phone numbers, email addresses and street addresses, and any other attributes that can be used to distinguish a customer.

As used herein, the phrases “paired attributes” or “corresponding attributes” are intended to mean attributes conveying the same type of customer information, each from a different customer record and/or customer profile that may be compared.

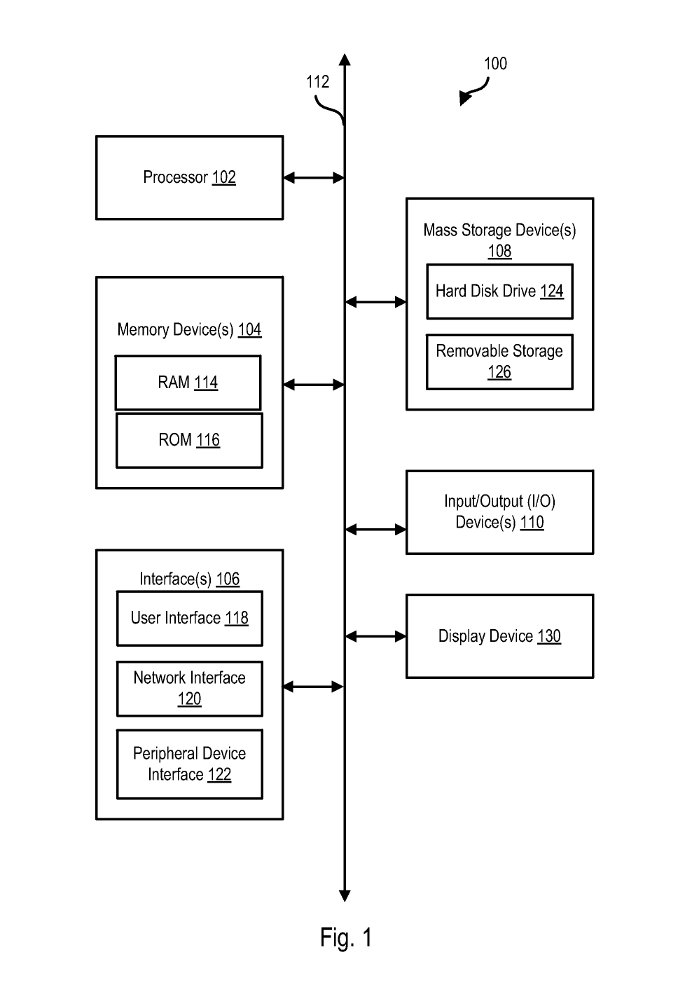

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, or any suitable user interface now known to those of ordinary skill in the field, or later discovered), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

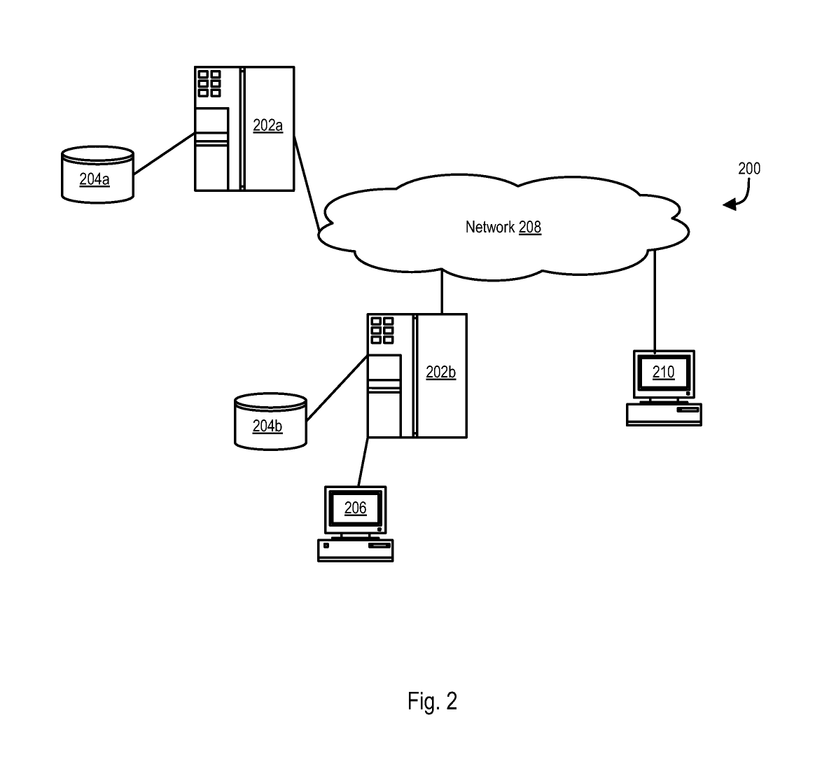

FIG. 2 illustrates an example of a computing environment 200 suitable for implementing the methods disclosed herein. In some implementations, a server 202a provides access to a database 204a in data communication therewith. The database 204a may store customer behavior and record information such as a user profile including such things as: contact information and identity information. The database 204a may additionally store behavior and transaction information contained in a plurality of records for a customer. The server 202a may provide access to the database 204a to users associated with a retailer, merchant or other user. The server 202a may provide and allow access to original source systems such as, for example, Experian™, Sam's Membership™, and the like. For example, the server 202a may implement a web server for receiving requests for data stored in the database 204a and formatting requested information into web pages. The web server may additionally be operable to receive information and store the information in the database 204a.

A server 202b may be associated with a retail merchant or by another entity providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator may access the server 202b by means of a workstation 206 that may be embodied as any general purpose computer, tablet computer, smart phone, or the like.

The server 202a and server 202b may communicate over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a, 202b, and databases 204a, 204b may have some or all of the attributes of the computing device 100.

The economic value of the data and network analysis of the disclosure, described herein, is great. One example describes methods for linking a plurality of records to a single customer such that meaning can be derived from a plurality of records that may otherwise remain unassociated. Increasingly, the economic value of accurate customer records may lie in a recommendation engine capability previously unrealized because customer records could not be linked with such accuracy. The disclosure provides a completely new method for providing such record linkages using genetic models where attributes are analogized with genetic traits and analyzed accordingly. Various genetic models may be used to provide cap values and weight values that may be used to provide linkages that are insensitive to any improper distortion created by attribute type correspondence that is disproportionate when compared to a known-accurate correspondence.

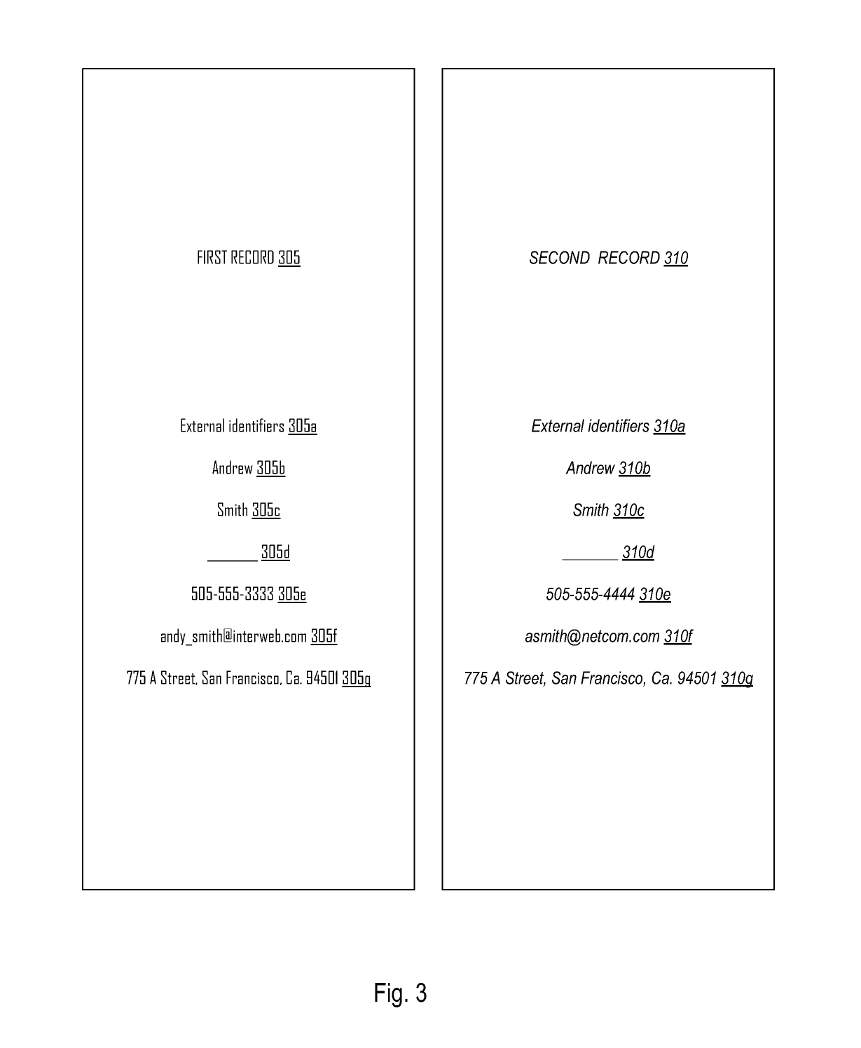

With reference primarily to FIG. 3, two simple customer records that correspond to the same customer are illustrated. As can be seen in the figure, customer records may be a customer profile comprising customer information such as: external identifiers 305a, 310a; names 305b, 305c, 310b, 310c; birthdate 305d, 310d; phone numbers 305e, 310e; email addresses 305f, 310f; street addresses 305g, 310g, and other like information that may be useful to a user. It may be typical that customers may have more than one phone number, or may have more than one email address. Accordingly, it would be common for a customer to provide different phone numbers during multiple transactions with a merchant and so the merchant's customer tracking system may not associate the records from all of the transactions. For example, as illustrated in the figure, the first record 305 contains a different phone number 305e than the phone number 310e of the second record 310. Various methods may be used to associate the two files with a customer, and certain models may yield better results depending on the attribute type that is being compared. In an embodiment, the customer attributes may be compared as computer readable strings of values that may be compared. Additionally, the individual attributes may be further divided or parsed into shorter character strings for increased speed of comparison.

It should be noted that the term “distance” is used to denote and calculate the strength of the similarity of attribute pairs. An attribute pair that is very similar will have a short distance between them, while dissimilar attributes will have a large distance value. In an embodiment, the comparison model evaluate the number of changes that it will take for a computer readable string representing a first attribute to completely match a string matching a second attribute.

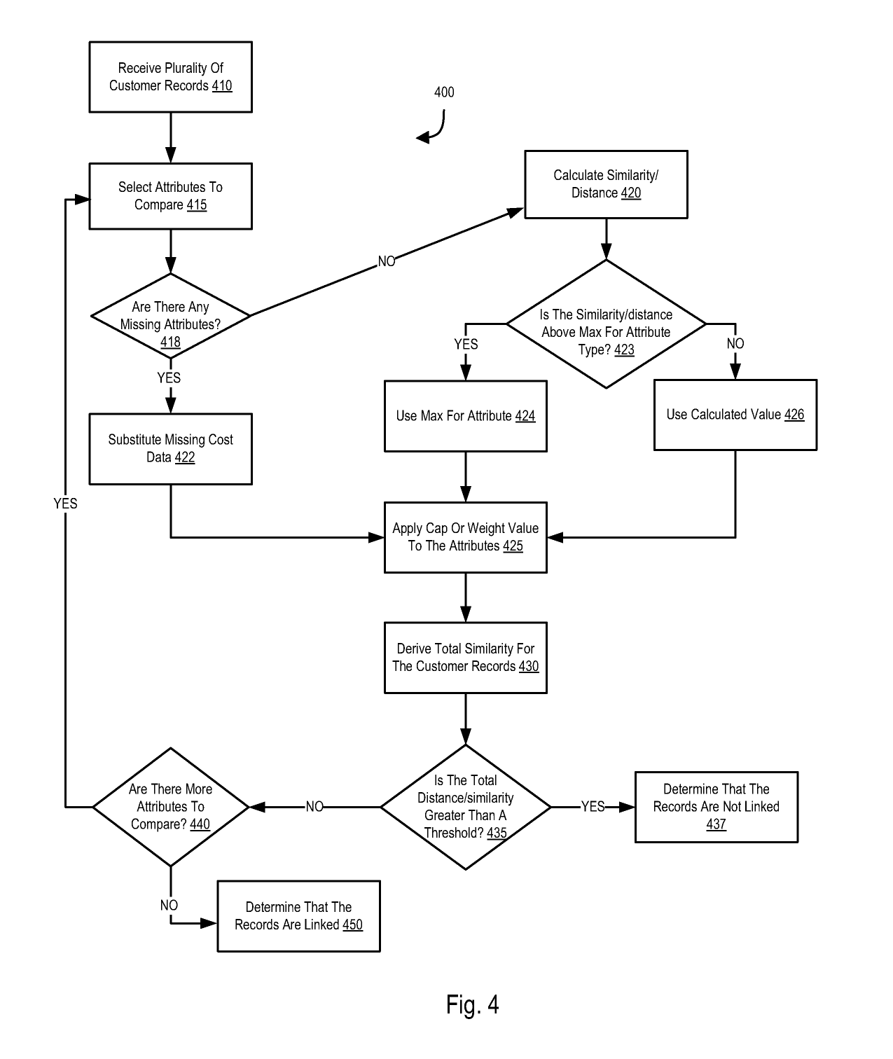

FIG. 4 illustrates an exemplary implementation of a capped linear combination model that may be used in order to optimize the linking of two customer profiles relative to each other such that similarities for one corresponding attribute pair do not overwhelm the other attribute pairs. The implementation may receive a collection of objects such as customer profiles that have corresponding and paired attributes at 410 of the method 400.

At 415, corresponding attributes may be selected from the plurality of records received at 410. The selection of attributes may be chosen based on the desired level of linking. For example, in some implementations it may be desirable to link all the members of a household, rather than specific individuals. Accordingly, the computer processing cost may be adjusted depending on the level chosen for linking.

At 418, the records may be checked for missing attribute values as illustrated in FIG. 3, wherein the birthdate attribute values 305d, 310d are missing. Missing attribute values may be critical to compensate for because in a situation where corresponding attributes from a plurality of customer profiles are left blank and non-compensated system would return a perfect match designation (or zero distance) and strongly skew the results and causing false linking.

At 420, if no missing attributes are found, then the corresponding attribute pairs from within the plurality of customer profile records may be compared to see if there are any paired “matches.” The system may comprise predetermined thresholds for matching attribute pairs or the thresholds may be determined on the fly. In an implementation, it may be desirous to set thresholds in order to find individuals at a household level, which typically may require a lower level of matching as discussed above. The collection of objects C may each have a set of attributes, a₁, . . . , aₖ. For example a₂ may be “first name” and a₂(c)=“Andrew” when c is a customer profile. For each of these attributes a distance metric for comparing two objects (customer profile records) may be:

fᵢ(c,c′)=L(aᵢ(c),aᵢ(c′))

for c, c′εC and 1≦i≦k where L is the Levenshtein distance of strings. It should be noted that in general any distance metric or dissimilarity metric may be used, not just Levenshtein distance, for comparing the attributes.

At 422, if missing attribute values are found, then substitute missing cost data may be inserted into the corresponding attribute fields in order to provide values that will preserve the accuracy of the linkage model.

At 423, the similarity/distance calculated at 420 may be tested against a predetermined threshold value that may be specific to each attribute type.

At 424, if the similarity/distance value is greater than the maximum threshold value, then the maximum threshold value should be used. Conversely, at 426, if the similarity/distance is less than the threshold value, then the calculated similarity/distance value should be used.

At 425 a weight or cap may be calculated to apply to the model during comparison. A capped linear combination model combines these together with different weights wᵢ and caps Mᵢ. The differing weights may correspond to the differing importance of the different attributes relative to matching at a certain level (individual or household). For example, in an embodiment, a phone number might be more important than the city of residence, and as such, differing caps may be used to normalize the model as desired. In an embodiment, differing weights may be selected and applied to different attribute types in order to provide certain limits on the influence of each attribute on the overall distance.

At 430 a weight or cap may be applied to attribute pairs so that a total similarity/distance value for the plurality of customer records may be derived. In an embodiment, it may be useful to have a low cap for the contribution of a different phone number because people often have multiple phone numbers, and a determination that the records do not match should not be made because the phone number is different. Thus, the capped linear combination distance can be written as

$$d ( c , {c}^{′} ) = {\sum }_{i = 1}^{k} {w}_{i} min ( {f}_{i} ( c , {c}^{′} ) , {M}_{i} )$$

for c, c′εC. Accordingly, for example if two attributes are provided with weights w₁=4, w₂=5 and caps M₁=20, M₂=10 then the capped linear combination distance would be:

d(c,c′)=4min(f₁(c,c′),20)+5min(f₂(c,c′),10)

At 435, a distance measure between corresponding weighted and/or capped attribute pairs may be tested against a threshold. In an embodiment, the weight may be made into a predictive classification model by adding a threshold T such that if d(c,c′)<T and may consider c and c′ to be matched. In an implementation this model may be made more accurate with the optimization of the constants w₁, . . . , wₖ, M₁, . . . , Mₖ, and T.

At 437, a determination of non-similarity, not-linked, may be made if the overall distance measure between two records falls above a predetermined threshold.

At 440, a determination that the records are linked if the overall distance measure between two records falls below a predetermined threshold. At 440, an implementation may check for further attribute pairs to be compared, and if there are more attributes to be compared then the process 410 through 435 may be repeated.

At 450, the determination of similarity may be recorded into computer memory linking and associating the plurality of records with the customer.

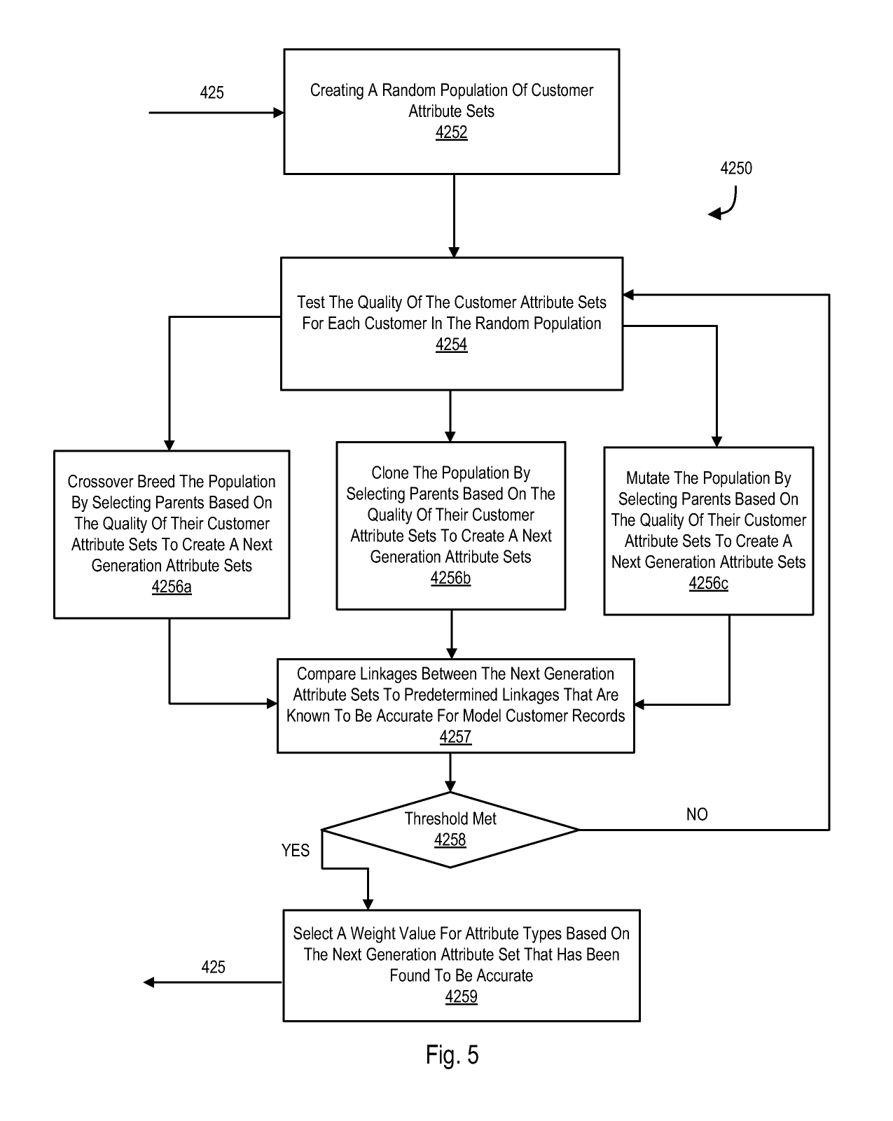

As illustrated in FIG. 5 the use of genetic algorithms may be used to derive optimal weights and caps for the attribute pairs as discussed briefly above. As illustrated in the figure, at 425 of method 400 of FIG. 4, genetic models may be used to derive weights and caps for use with a customer linkage model in order to produce a more accurate method. At 4252 of method 4250, a random population of customer attribute sets is created for deriving weights and caps therefrom. The attributes sets may be customer profiles having attribute pairs that may be linked.

At 4254, the quality of the customer attribute sets may be tested for breeding fitness. It should be noted that in genetic modeling, generally the most fit population members are more likely to breed and produce offspring. Accordingly, the higher quality customer attribute sets are more likely to combine and yield useable outcomes.

At 4256a, the customer attribute sets may be crossover bred based on the quality customer attribute sets to produce next generation attribute set. It should be noted that certain attribute types may be better suited to crossover breeding and therefore will produce more accurate weight and cap values to be applied to certain attributes.

At 4256b, the customer attribute sets may be cloned based on the quality customer attribute sets relative to cloning to produce a next generation of attribute sets. Certain attribute types may be better suited to cloning and therefore will produce more accurate weight and cap values that may be applied to certain attributes with greater success.

At 4256c, the customer attribute sets may be mutated based on the quality customer attribute sets relative to mutations to produce a next generation of attribute sets. Certain attribute types may be better suited to mutations and therefore will produce more accurate weight and cap values that may be applied to certain attributes with greater success.

At 4257, the next generation attribute sets may be compared for linkage strength when compared to model customer attribute sets that are known to be accurate.

At 4258, it may be determined whether a predetermined threshold is met when the comparison at 4257 is performed. If the threshold is not met, then process steps 4254 through 4257 may be repeated until the threshold is met.

At 4259, once the threshold is met, a weight and/or cap value for the attribute sets may be selected and used in the customer linkage model 400.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for determining the similarity of a plurality of electronic records representing a customer and having missing attributes comprising:
receiving a plurality of records comprising customer information, by a network server, wherein the records comprise attributes of the customer;
comparing attributes from the records to determine similarity between corresponding attributes of the same attribute type from within the first and second records;
wherein the attributes are compared as a string of computer readable characters;
determining if the records are missing attribute values in attribute fields;
assigning missing cost value to missing attribute fields;
assigning a cap values for attribute types;
deriving an attribute distance measure between the corresponding attributes of the records;
calculating an overall distance measure between the corresponding attributes of the records from a calculated combination of a plurality of attribute distance measures;
making a determination of similarity between the corresponding attributes of the records represent the same customer if the overall distance measure falls below a predetermined threshold; and
recording the determination of similarity into computer memory associating the plurality of records with the customer.

2. The method of claim 1, wherein the cap value is derived by:
creating a random population of customer attribute sets;
testing the quality of the customer attribute sets for each customer in the random population;
breeding the population by selecting parents based on the quality of their customer attribute sets to create a next generation attribute sets;
comparing linkages between the next generation attribute sets to predetermined linkages that are known to be accurate for model customer records;
selecting a cap value for attribute types based on the next generation attribute set that has been found to be accurate.

3. The method of claim 2, wherein breeding comprises clone genetic modeling of attributes.

4. The method of claim 2, wherein breeding comprises mutation genetic modeling of attributes.

5. The method of claim 2, wherein breeding comprises crossover genetic modeling of attributes.

6. The method of claim 1, wherein the customer represents a household of customers.

7. The method of claim 1, wherein the following processes are repeated to increase accuracy:
testing the quality of the customer attribute sets for each customer in the random population;
breeding the population by selecting parents based on the quality of their customer attribute sets to create a next generation attribute sets;
comparing linkages between the next generation attribute sets to predetermined linkages that are known to be accurate for model customer records; and
selecting a cap value for attribute types based on the next generation attribute set that has been found to be accurate.

8. The method of claim 1, wherein the plurality of customer records comprise attributes selected from the group of: external identifiers; first name; last name, date of birth; phone numbers; email addresses; street addresses.

9. The method of claim 1, further comprising determining whether the plurality of records are missing corresponding attribute pairs.

10. The method of claim 9, further comprising assigning differing missing cost values in the attribute fields such that corresponding attribute pairs will have different substituted values.

11. A system for determining a customer linkages of a plurality of customer profiles comprising one or more processors and one or more memory devices operably coupled to the one or more processors and storing executable and operational data, the executable and operational data effective to cause the one or more processors to:
receive a first record of customer information, by a network server, wherein the first record comprises attributes of the customer;
receive a second record of customer information, by a network server, wherein the second record comprises attributes of the customer;
compare attributes from the first and second records to determine similarity between corresponding attributes of the same attribute type from within the first and second records;
wherein the attributes are compared as a string of computer readable characters;
assign a cap value to an attribute type;
wherein the cap value is derived by:
creating a random population of customer attribute sets;
testing the quality of the customer attribute sets for each customer in the random population;
breeding the population by selecting parents based on the quality of their customer attribute sets to create a next generation attribute sets;
comparing linkages between the next generation attribute sets to predetermined linkages that are known to be accurate for model customer records;
selecting a cap value for attribute types based on the next generation attribute set that has been found to be accurate;
derive an attribute distance measure between the corresponding attributes of first and second records;
calculate an overall distance measure between the first and second records from a calculated combination of a plurality of attribute distance measures;
make a determination of similarity that the first and second records represent the same customer if the overall distance measure falls below a predetermined threshold; and
record the determination of similarity into computer memory associating the plurality of records with the customer.

12. A system according to claim 11, further comprising assigning a weight value to an attribute type.

13. A system according to claim 11, wherein breeding comprises clone genetic modeling of attributes.

14. A system according to claim 11, wherein breeding comprises mutation genetic modeling of attributes.

15. A system according to claim 11, wherein breeding comprises crossover genetic modeling of attributes.

16. A system according to claim 11, wherein the customer represents a household of customers.

17. A system according to claim 11, wherein the following processes are repeated to increase accuracy:
testing the quality of the customer attribute sets for each customer in the random population;
breeding the population by selecting parents based on the quality of their customer attribute sets to create a next generation attribute sets;
comparing linkages between the next generation attribute sets to predetermined linkages that are known to be accurate for model customer records; and
selecting a cap value for attribute types based on the next generation attribute set that has been found to be accurate.

18. A system according to claim 11, wherein the plurality of customer records comprise attributes selected from the group of: external identifiers; first name; last name, date of birth; phone numbers; email addresses; street addresses.

19. A system according to claim 11, further comprising determining whether the plurality of records are missing corresponding attribute pairs.

20. A system according to claim 19, further comprising assigning differing missing cost values in the attribute fields such that corresponding attribute pairs will have different substituted values.
